(19) United States
(12) Patent Application Publication
(10) Pub. No.: US 2024/0012621 A1
(43) Pub. Date: Jan. 11, 2024

(54) METHOD OF REWRITING PROGRAMS OF PLURALITY OF ELECTRONIC DEVICES IN WATERCRAFT SYSTEM AND WATERCRAFT SYSTEM

(71) Applicant: YAMAHA HATSUDOKI KABUSHIKI KAISHA, IWATA-SHI (JP)

(72) Inventor: Takaaki BAMBA, Shizuoka (JP)

(21) Appl. No.: 18/208,906

(22) Filed: Jun. 13, 2023

(30) Foreign Application Priority Data
Jul. 8, 2022 (JP) 2022-110636

(51) Int. Cl. G06F 8/30

(52) U.S. Cl. CPC G06F 8/30

(57) ABSTRACT

A method of rewriting programs of first and second electronic controllers includes transmitting data for rewriting each of the programs to each of the first and second electronic controllers with a common identifier through a communication network, causing the first electronic controller to rewrite the program thereof when the first electronic controller determines to rewrite the program thereof, causing the first electronic controller not to rewrite the program thereof when the first electronic controller determines not to rewrite the program thereof, causing the second electronic controller to rewrite the program thereof when the second electronic controller determines to rewrite the program thereof, and causing the second electronic controller not to rewrite the program thereof when the second electronic controller determines not to rewrite the program thereof.

### CROSS REFERENCE TO RELATED APPLICATIONS

This application claims the benefit of priority to Japanese Patent Application No. 2022-110636 filed on Jul. 8, 2022. The entire contents of this application are hereby incorporated herein by reference.

### BACKGROUND OF THE INVENTION

### 1. Field of the Invention

The present invention relates to a method of rewriting programs of a plurality of electronic devices in a watercraft system and also relates to a watercraft system.

### 2. Description of the Related Art

A marine propulsion device such as an outboard motor is mounted to a watercraft. The marine propulsion device includes an electronic control device. The electronic control device is connected to a communication network such as a CAN (Controller Area Network). For example, as described in Japan Laid-open Patent Application Publication No. 2020-179748, when a program of an electronic control device is updated, a computer for rewriting the program is connected to the electronic control device through a communication network. The computer rewrites the program of the electronic control device by utilizing a rewriting protocol such as UDS (Unified Diagnostic Services). In this case, the computer specifies an identifier of the electronic control device and vice versa. Accordingly, a peer-to-peer communication is established therebetween. Under this condition, data transmission and reception are made therebetween so as to rewrite the program.

There is a type of watercraft provided with a system including a plurality of marine propulsion devices. In this system, a plurality of electronic control devices of the plurality of marine propulsion devices are connected to each other through a communication network. The electronic control devices are identical in function to each other but are identified as discrete devices in the communication network. Because of this, identifiers are uniquely assigned to the electronic control devices, respectively.

In the system including the marine propulsion devices as described above, when the programs of the electronic control devices are rewritten, the computer is configured to rewrite the programs of the electronic control devices, separately. Because of this, a length of time required for rewriting the programs inevitably increases with an increase in the number of the electronic control devices.

### SUMMARY OF THE INVENTION

Preferred embodiments of the present invention reduce a length of time required for rewriting programs of a plurality of electronic controllers in a system for a watercraft including a plurality of marine propulsion devices.

A method according to a preferred embodiment of the present invention includes rewriting a program of a first electronic controller and a program of a second electronic controller in a watercraft system. The watercraft system includes a first marine propulsion device, a second marine propulsion device, and a communication network. The first marine propulsion device includes the first electronic controller, the second marine propulsion device includes the second electronic controller, and the communication network connects the first electronic controller and the second electronic controller. The method includes transmitting data for rewriting each of the programs to each of the first and second electronic controllers with a common identifier through the communication network, causing the first electronic controller to determine whether or not to rewrite the program thereof and then either causing the first electronic controller to rewrite the program thereof when the first electronic controller determines to rewrite the program thereof, or causing the first electronic controller not to rewrite the program thereof when the first electronic controller determines not to rewrite the program thereof, and causing the second electronic controller to determine whether or not to rewrite the program thereof and then either causing the second electronic controller to rewrite the program thereof when the second electronic controller determines to rewrite the program thereof, or causing the second electronic controller not to rewrite the program thereof when the second electronic controller determines not to rewrite the program thereof.

A watercraft system according to another preferred embodiment of the present invention includes a first marine propulsion device, a second marine propulsion device, a communication network, and a computer. The first marine propulsion device includes a first electronic controller, the second marine propulsion device includes a second electronic controller, and the communication network connects the first electronic controller and the second electronic controller. The computer is connected to the communication network and rewrites a program of the first electronic controller and a program of the second electronic controller. The computer transmits data for rewriting each of the programs to each of the first and second electronic controllers with a common identifier through the communication network. The first electronic controller receives the data and determines whether or not to rewrite the program thereof. The first electronic controller rewrites the program thereof when it is determined to rewrite the program thereof but does not rewrite the program thereof when it is determined not to rewrite the program thereof. The second electronic controller receives the data and determines whether or not to rewrite the program thereof. The second electronic controller rewrites the program thereof when it is determined to rewrite the program thereof but does not rewrite the program thereof when it is determined not to rewrite the program thereof.

According to preferred embodiments of the present invention, the data for rewriting each of the programs are transmitted to each of the plurality of electronic controllers with the common identifier through the communication network. This results in a reduction in the length of time required for rewriting the programs of the plurality of electronic controllers. Besides, each of the plurality of electronic controllers determines whether or not to rewrite the program thereof. Because of this, the computer for rewriting the programs is not required to determine whether or not to rewrite the program in each of the plurality of electronic controllers. Thus, the processes to be executed by the computer are simplified.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram showing a watercraft according to a preferred embodiment of the present invention.

FIG. 2 is a side view of a marine propulsion device.

FIG. 3 is a schematic diagram showing a control system for the watercraft.

FIG. 4 is a flowchart showing a series of processes executed by a computer to rewrite a program of an ECU (Engine Control Unit).

FIG. 5 is a flowchart showing a series of processes executed by the computer to rewrite the program of the ECU.

FIG. 6 is a flowchart showing a series of processes executed by the ECU when the ECU receives a command to update the frequency of rewriting.

### DETAILED DESCRIPTION OF THE PREFERRED EMBODIMENTS

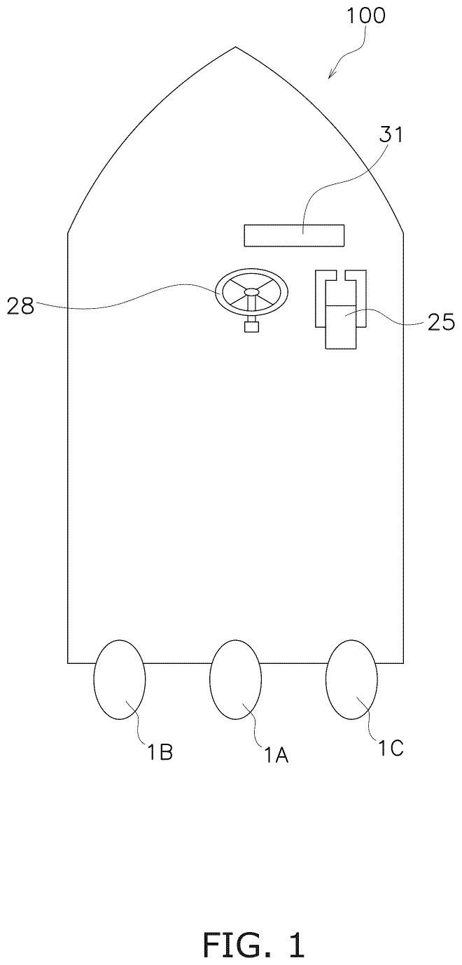

Preferred embodiments of the present invention will be hereinafter explained with reference to the drawings. FIG. 1 is a perspective view of a watercraft 100 according to a preferred embodiment of the present invention. A plurality of marine propulsion devices 1A to 1C are attached to the stern of the watercraft 100. Each of the marine propulsion devices 1A to 1C generates a thrust to propel the watercraft 100. In the present preferred embodiment, the marine propulsion devices 1A to 1C are outboard motors. The marine propulsion devices 1A to 1C include a first marine propulsion device 1A, a second marine propulsion device 1B, and a third marine propulsion device 1C.

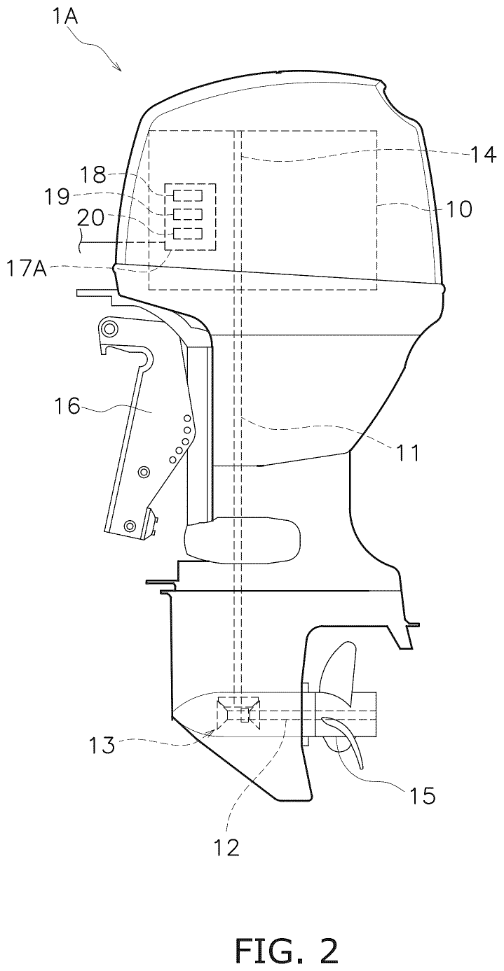

FIG. 2 is a side view of the first marine propulsion device 1A. As shown in FIG. 2, the first marine propulsion device 1A includes an engine 10, a drive shaft 11, a propeller shaft 12, and a shift mechanism 13. The engine 10 generates the thrust to propel the watercraft 100. The engine 10 includes a crankshaft 14 that extends in the vertical direction. The drive shaft 11 is connected to the crankshaft 14, and extends in the vertical direction and downward from the engine 10.

The propeller shaft 12 extends in the back-and-forth direction of the first marine propulsion device 1A. The propeller shaft 12 is connected to the drive shaft 11 through the shift mechanism 13. A propeller 15 is connected to the propeller shaft 12. The shift mechanism 13 switches the rotational direction of mechanical power to be transmitted from the drive shaft 11 to the propeller shaft 12. The shift mechanism 13 includes, for instance, a plurality of gears and a clutch that changes meshing of the gears. The first marine propulsion device 1A is attached to the watercraft 100 through a bracket 16.

The first marine propulsion device 1A includes a first ECU (Engine Control Unit) 17A. The first ECU 17A is an electronic control device to control the engine 10. The first ECU 17A includes a processor 18 such as a CPU (Central Processing Unit), a RAM (Random Access Memory) 19, and a flash ROM (Read Only Memory) 20. The flash ROM 20 stores programs to control the engine 10. The first ECU 17A is programmed to electrically control the engine 10.

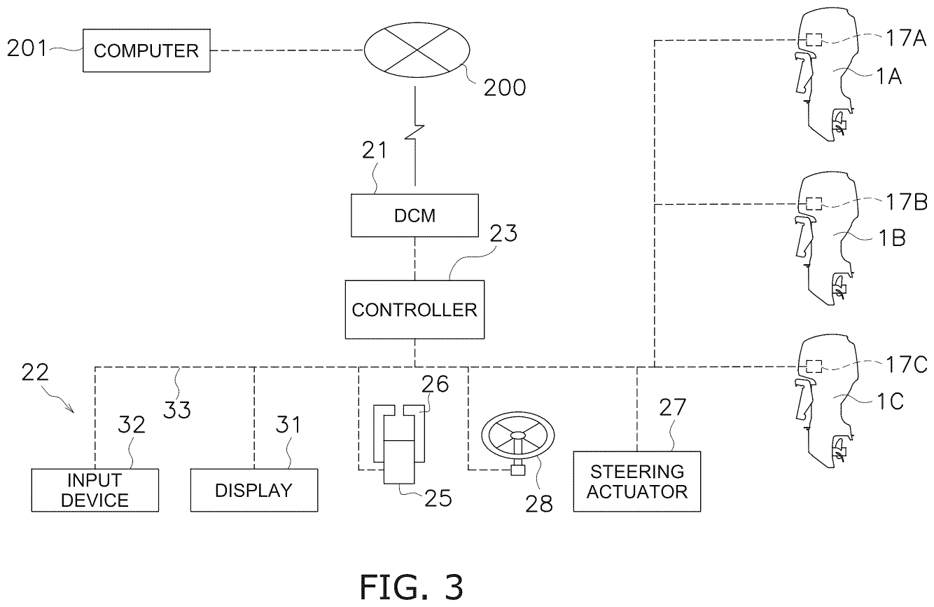

FIG. 3 is a schematic diagram showing a configuration of a watercraft system installed in the watercraft 100. As shown in FIG. 3, the second marine propulsion device 1B includes a second ECU 17B. The third marine propulsion device 1C includes a third ECU 17C. Each of the second and third ECUs 17B and 17C is similar in configuration and function to the first ECU 17A. The other constituent elements in each of the second and third marine propulsion devices 1B and 1C are similar to those in the first marine propulsion device 1A.

As shown in FIG. 3, the watercraft system includes a data communication module (hereinafter referred to as DCM) 21, a device system 22, and a controller 23. The DCM 21 performs wireless communication with an external computer 201. For example, the DCM 21 is able to perform data transmission with the external computer 201 through a mobile communication network 200. The mobile communication network 200 is, for instance, a network of a 3G, 4G, or 5G mobile communication system.

The device system 22 includes electric devices installed in the watercraft 100. For example, the device system 22 includes the first to third ECUs 17A to 17C described above. The device system 22 includes a throttle-shift operating device 25. The throttle-shift operating device 25 is operable by an operator to regulate the rotational speed of the engine 10 in each of the first to third marine propulsion devices 1A to 1C. Besides, the throttle-shift operating device 25 is operable by the operator to perform switching between a forward moving action and a rearward moving action by each of the first to third marine propulsion devices 1A to 1C.

The throttle-shift operating device 25 includes a throttle lever 26. The throttle lever 26 is operable from a neutral position to a forward moving position and a rearward moving position. The throttle-shift operating device 25 outputs a throttle signal indicating the operating position of the throttle lever 26. Each ECU 17A, 17B, 17C receives the throttle signal from the throttle-shift operating device 25. Each ECU 17A, 17B, 17C controls the shift mechanism 13 corresponding thereto in accordance with the operating position of the throttle lever 26. Accordingly, the rotational direction of the propeller shaft 12 corresponding thereto is switched between a forward moving direction and a rearward moving direction. Each ECUs 17A, 17B, 17C controls the rotational speed of the engine 10 corresponding thereto depending on the operating position of the throttle lever 26.

The device system 22 includes a steering actuator 27 and a steering operating device 28. The steering actuator 27 turns each marine propulsion device 1A, 1B, 1C right and left so as to change the rudder angle of each marine propulsion device 1A, 1B, 1C. The steering actuator 27 includes, for instance, an electric motor. Alternatively, the steering actuator 27 may include an electric pump and a hydraulic cylinder.

The steering operating device 28 is operable by the operator to adjust the rudder angle of each marine propulsion device 1A, 1B, 1C. The steering operating device 28 includes, for instance, a steering wheel. Alternatively, the steering operating device 28 may be another type of operating device such as a joystick. The steering operating device 28 is operable right and left from a neutral position. The steering operating device 28 outputs a steering signal indicating the operating position thereof. The steering actuator 27 is controlled depending on the operating position of the steering operating device 28, such that the rudder angle of each marine propulsion device 1A, 1B, 1C is controlled.

The device system 22 includes a display 31 and an input device 32. The display 31 displays information regarding each marine propulsion device 1A, 1B, 1C. The display 31 displays an image in accordance with an image signal inputted thereto. The input device 32 receives an operational input by a user. The input device 32 outputs an input signal indicating the operational input by the user. The input device 32 includes, for instance, a touchscreen. However, the input device 32 may include at least one hardware key. The device system 22 includes a CAN (Controller Area Network) 33. The CAN 33 is a communication network that the electric devices, included in the device system 22, are connected to each other.

The controller 23 includes a processor such as a CPU and memories such as a RAM and a ROM. The controller 23 controls the device system 22. For example, the controller 23 controls the device system 22 in accordance with the input signal transmitted thereto from the input device 32. The controller 23 outputs the image signal to the display 31 so as to cause the display 31 to display a desired image. The device system 22 is connected to the DCM 21 through the controller 23.

A computer 201 is connected to the CAN 33 through the DCM 21. The computer 201 rewrites a program of each ECU 17A, 17B, 17C by utilizing a protocol to rewrite the program such as UDS (Unified Diagnostic Services). A series of processes to rewrite the program of each ECU 17A, 17B, 17C will be hereinafter explained.

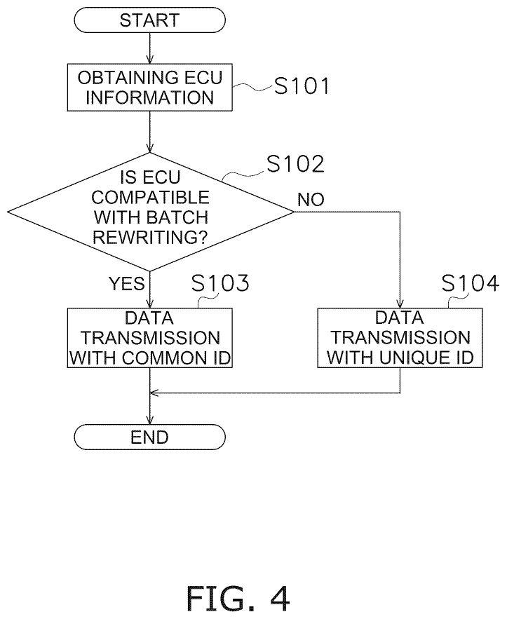

FIG. 4 is a flowchart showing a series of processes executed by the computer 201 to rewrite the program of each ECU 17A, 17B, 17C. As shown in FIG. 4, in step S101, the computer 201 obtains ECU information from each ECU 17A, 17B, 17C. The ECU information includes the protocol version, the frequency of rewriting the program, and the serial number of each ECU 17A, 17B, 17C. It should be noted that the computer 201 obtains the ECU information by another communication protocol different from the rewriting protocol in the CAN 33 described above. In another communication protocol herein described, IDs are set for a plurality of ECUs so as to distinguish the ECUs from one another even when the ECUs are of an identical type. For instance, SAE J1939 may be used as another communication protocol. This is because, when receiving multiple packet responses from the ECUs 17A to 17C in communication under the rewriting protocol, the computer 201 cannot correctly distinguish the responses from the ECUs 17A to 17C from one another.

In step S102, the computer 201 determines whether or not each ECU 17A, 17B, 17C is compatible with batch rewriting. The computer 201 determines whether or not each ECU 17A, 17B, 17C is compatible with the batch rewriting based on the version of the protocol of each ECU 17A, 17B, 17C.

When each ECU 17A, 17B, 17C is compatible with the batch rewriting, the process proceeds to step S103. In step S103, the computer 201 transmits data for rewriting the program of each ECU 17A, 17B, 17C to each ECU 17A, 17B, 17C with a common identifier for the batch rewriting. The common identifier has been preliminarily set to each ECU 17A, 17B, 17C having a protocol version compatible with the batch rewriting.

When each ECU 17A, 17B, 17C is incompatible with the batch rewriting in step S102, the process proceeds to step S104. In step S104, the computer 201 transmits the data for rewriting the program to each ECU 17A, 17B, 17C with a unique identifier for discrete rewriting. The unique identifier has been preliminarily assigned and set to each ECU 17A, 17B, 17C having a protocol version incompatible with the batch rewriting.

For example, when it is determined that the first and second ECUs 17A and 17B are compatible with the batch rewriting, the computer 201 simultaneously transmits the data for rewriting the program to the first and second ECUs 17A and 17B with an identifier common to the first and second ECUs 17A and 17B. On the other hand, when it is determined that the third ECU 17C is incompatible with the batch rewriting, the computer 201 transmits the data for rewriting the program to the third ECU 17C with an identifier uniquely assigned to the third ECU 17C. In other words, the computer 201 separately executes data transmission to the first and second ECUs 17A and 17B with the common identifier and data transmission to the third ECU 17C with the unique identifier.

Alternatively, when it is determined that all the first to third ECUs 17A to 17C are compatible with the batch rewriting, the computer 201 simultaneously transits the data for rewriting the program to the first to third ECUs 17A to 17C with an identifier common to the first to third ECUs 17A to 17C. Contrarily, when it is determined that all the first to third ECUs 17A to 17C are incompatible with the batch rewriting, the computer 201 sequentially transmits the data for rewriting the program to the first to third ECUs 17A to 17C with identifiers uniquely assigned to the first to third ECUs 17A to 17C, respectively.

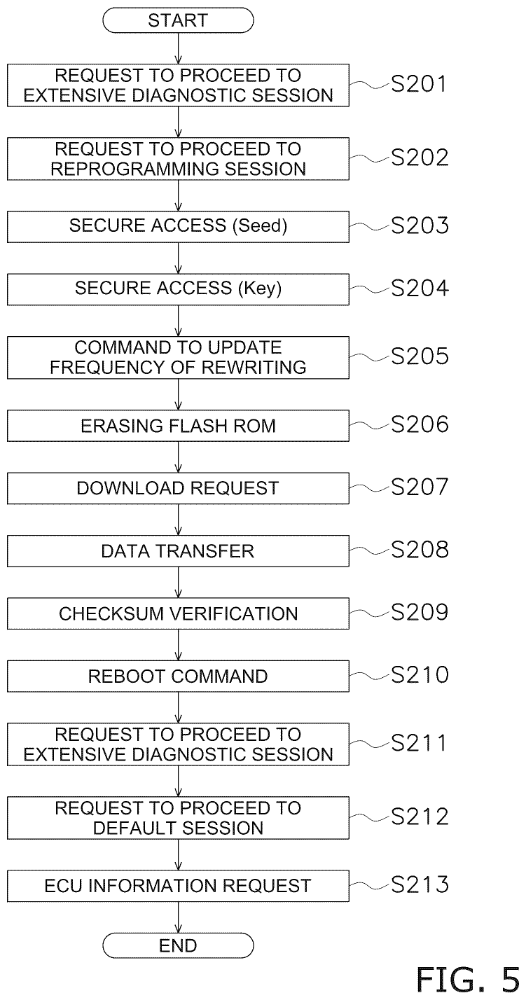

When given ECUs are compatible with the batch rewriting, the computer 201 executes a series of processes shown in FIG. 5 to transmit data to the given ECUs with an identifier common to the given ECUs. In the following explanation, it is assumed that the first and second ECUs 17A and B are compatible with the batch rewriting, whereas the third ECU 17C is incompatible with the batch rewriting.

As shown in FIG. 5, in step S201, the computer 201 transmits a request to proceed to an extensive diagnostic session to each ECU 17A, 17B. In step S202, the computer 201 transmits a request to proceed to a reprogramming session to each ECU 17A, 17B.

In step S203, the computer 201 transmits “Seed” for secure access to each ECU 17A, 17B. In step S204, the computer 201 transmits “Key” for secure access to each ECU 17A, 17B. It should be noted that the Key is processed as an error in a given ECU other than each ECU 17A, 17B associated with the Key. Thus, the number of Keys transmitted from the computer 201 is equal to the number of the ECUs 17A and 17B associated with the Keys. Besides, the ECUs 17A and 17B allow errors to occur at a frequency of “the number of ECUs −1”.

In step S205, the computer 201 transmits a command to update the frequency of rewriting. The computer 201 transmits, not a specific value of frequency, but a command to increase by one the frequency of rewriting, to each ECU 17A, 17B.

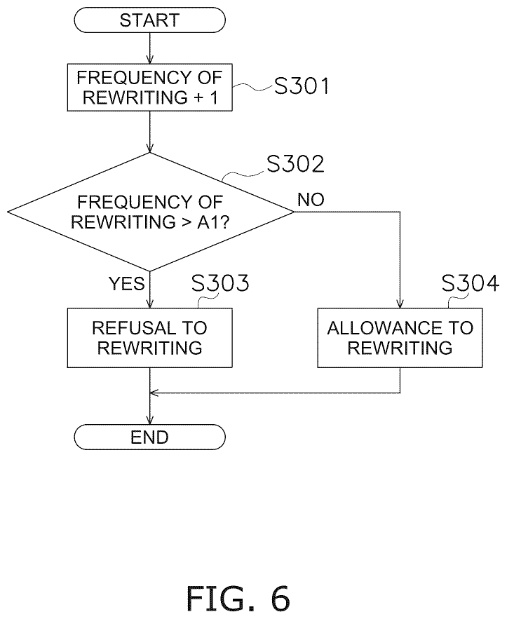

FIG. 6 is a flowchart showing a series of processes executed by each ECU 17A, 17B when each ECU 17A, 17B receives the command to update the frequency of rewriting. For example, suppose the first ECU 17A receives the command to update the frequency of rewriting. As shown in FIG. 6, the first ECU 17A increases by one the frequency of rewriting executed therein in step S301. When the upper limit is set for the frequency of rewriting in the ECU 17A, the first ECU 17A determines whether or not the frequency of rewriting is greater than a set value A1 in step S302.

When the first ECU 17A determines that the frequency of rewriting is greater than the set value A1 in step S302, the process proceeds to step S303. In step S303, the first ECU 17A does not rewrite the program. In this case, the first ECU 17A transmits a negative response to the computer 201. When receiving the negative response from the first ECU 17A, the computer 201 determines that the program is not rewritable in the first ECU 17A.

When the first ECU 17A determines that the frequency of rewriting is not greater than the set value A1 in step S302, the process proceeds to step S304. In step S304, the first ECU 17A accepts rewriting of the program. In this case, the first ECU 17A transmits a positive response to the computer 201. It should be noted that, even when the upper limit is not set for the frequency of rewriting in the first ECU 17A, the first ECU 17A transmits the positive response to the computer 201. When receiving the positive response from the first ECU 17A, the computer 201 determines that the program is rewritable in the first ECU 17A. Likewise, the second ECU 17B executes the series of processes described above, when receiving the command to update the frequency of rewriting.

In step S206, the computer 201 transmits a command to erase the flash ROM to each ECU 17A, 17B. It should be noted that a given ECU, in which the program is not rewritable, transmits a negative response with respect to the series of processes in step S206 and thereafter, whereas only another ECU, in which the program is rewritable, continues executing the series of processes in step S206 and thereafter.

In step S207, the computer 201 transmits a download request to each ECU 17A, 17B. When there is a difference in response to the download request between the ECUs 17A and 17B (e.g., a difference in volume of acceptable data or a difference in request for intervals of communication time), the computer 201 executes data transfer in accordance with the least strict one of the conditions obtained from the responses. Each ECU 17A, 17B transmits a response based on the volume of data transmission declared by the computer 201. In short, the computer 201 does not execute a process depending on a value requested by each ECU 17A, 17B.

In step S208, the computer 201 transmits updated program data to each ECU 17A, 17B. Each ECU 17A, 17B rewrites the program based on the received program data. For example, when accepting to rewrite the program, the first ECU 17A rewrites the program based on the program data received from the computer 201. When rejecting to rewrite the program, the first ECU 17A does not rewrite the program.

When transmission of the program data is completed, the computer 201 transmits a checksum verification to each ECU 17A, 17B in step S209. In step S210, the computer 201 transmits a reboot command to each ECU 17A, 17B. In step S211, the computer 201 transmits a request to proceed to an extensive diagnostic session to each ECU 17A, 17B. In step S212, the computer 201 transmits a request to proceed to a default session to each ECU 17A, 17B.

In step S213, the computer 201 transmits an ECU information request to each ECU 17A, 17B. In similar manner to step S101 described above, the computer 201 obtains the ECU information with another communication protocol different from the rewriting protocol in the CAN 33.

It should be noted that each ECU 17A, 17B transmits a response with respect to each process described above; then, the computer 201 executes the following processes after receiving the response from each ECU 17A, 17B. When any kind of error occurs in either the ECU 17A or the ECU 17B in the series of processes executed before the step of erasing the flash ROM, the computer 201 determines that the program is not rewritable in the ECU in which any kind of error occurs but continues executing the batch rewriting. On the other hand, even when any kind of error occurs in either the ECU 17A or the ECU 17B in the series of processes at and after the step of erasing the flash ROM, the computer 201 executes the batch rewriting until the end. In other words, when a given ECU has a chance of success of rewriting, the computer 201 executes the series of processes with respect to the given ECU until the end of rewriting. Accordingly, the occurrence of a malfunction in the software is prevented in each ECU 17A, 17B.

The computer 201 transmits data to the third ECU 17C incompatible with the batch rewriting with an identifier uniquely assigned to the third ECU 17C in a series of processes similar to that described above.

In the watercraft system according to a preferred embodiment explained above, the data for rewriting the program are transmitted to each of the plurality of ECUs 17A and 17B with the common identifier through the CAN 33. Because of this, rewriting of the program is simultaneously executed with respect to the ECUs 17A and 17B compatible with the batch rewriting. This results in a reduction in the length of time required for rewriting the programs of the plurality of ECUs 17A and 17B. When the plurality of ECUs 17A to 17C include not only one or more ECUs compatible with the batch rewriting but also one or more ECUs incompatible with the batch rewriting, the discrete rewriting of the program can be executed with respect to the one or more ECUs incompatible with the batch rewriting.

Each of the plurality of ECUs 17A and 17B determines whether or not to rewrite the program thereof. Because of this, the computer 201 is not required to determine whether or not to rewrite the program in each of the plurality of ECUs 17A and 17B. Thus, the process to be executed by the computer 201 is simplified.

Preferred embodiments of the present invention have been described above. However, the present invention is not limited to the preferred embodiments described above, and a variety of changes can be made without departing from the gist of the present invention.

Each marine propulsion device 1A, 1B, 1C is not limited to the outboard motor, and alternatively, may be another type of propulsion device such as an inboard engine outboard drive or a jet propulsion device. The structure of each marine propulsion device 1A, 1B, 1C is not limited to that in the preferred embodiments described above and may be changed. For example, each marine propulsion device 1A, 1B, 1C may include an electric motor instead of the engine.

The number of marine propulsion devices is not limited to three. The number of marine propulsion devices may be two or may be more than three. The electronic control device is not limited to the ECU described above and may be changed. For example, when each marine propulsion device includes an electric motor as a drive source, the electronic control device may be a motor controller to control the electric motor.

The condition for rewriting the program is not limited to that the frequency of rewriting the program has not reached the set value. Another condition may be set as an additional condition for rewriting the program. For example, a condition that at least one of the marine propulsion devices is not in operation or a condition that a voltage applied to each ECU is greater than or equal to a predetermined value may be set as an additional condition for rewriting the program.

In the preferred embodiments described above, the computer 201 is connected to the CAN 33 through the mobile communication network 200. However, the computer 201 may be connected to the CAN 33 through a wired communication or a short-range wireless communication including a WLAN (wireless local area network), Bluetooth (registered trademark), or so forth.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method of rewriting a program of a first electronic controller and a program of a second electronic controller in a watercraft system, the watercraft system including a first marine propulsion device including the first electronic controller, a second marine propulsion device including the second electronic controller, and a communication network to connect the first electronic controller and the second electronic controller, the method comprising:
transmitting data for rewriting each of the programs to each of the first and second electronic controllers with a common identifier through the communication network;
causing the first electronic controller to determine whether or not to rewrite the program thereof and then either causing the first electronic controller to rewrite the program thereof when the first electronic controller determines to rewrite the program thereof, or causing the first electronic controller not to rewrite the program thereof when the first electronic controller determines not to rewrite the program thereof; and
causing the second electronic controller to determine whether or not to rewrite the program thereof and then either causing the second electronic controller to rewrite the program thereof when the second electronic controller determines to rewrite the program thereof, or causing the second electronic controller not to rewrite the program thereof when the second electronic controller determines not to rewrite the program thereof.

2. The method according to claim 1, wherein the watercraft system further includes a third marine propulsion device including a third electronic controller, the method further comprising:
determining whether or not each of the first, second, and third electronic controllers is compatible with batch rewriting of the program of the first electronic controller, the program of the second electronic controller, and a program of the third electronic controller with the common identifier;
transmitting the data for rewriting the each of the programs to the each of the first and second electronic controllers with the common identifier when the first and second electronic controllers are determined to be compatible with the batch rewriting; and
transmitting data for rewriting the program of the third electronic controller to the third electronic controller with an identifier uniquely assigned to the third electronic controller so as to be different from the common identifier when the third electronic controller is determined to be incompatible with the batch rewriting.

3. The method according to claim 2, further comprising:
obtaining a version of a protocol for rewriting each of the programs of the first, second, and third electronic controllers from the each of the first, second, and third electronic controllers; and
determining whether or not the each of the first, second, and third electronic controllers is compatible with the batch rewriting based on the version of the protocol thereof.

4. The method according to claim 1, further comprising:
causing the each of the first and second electronic controllers to determine whether or not a predetermined rewriting condition is satisfied;
causing the each of the first and second electronic controllers to determine to rewrite the program thereof when the predetermined rewriting condition is satisfied; and
causing the each of the first and second electronic controllers to determine not to rewrite the program thereof when the predetermined rewriting condition is not satisfied.

5. The method according to claim 4, wherein the predetermined rewriting condition is one of a plurality of rewriting conditions including that a frequency of rewriting the each of the programs has not reached a set value.

6. A watercraft system comprising:
a first marine propulsion device including a first electronic controller;
a second marine propulsion device including a second electronic controller;
a communication network connecting the first electronic controller and the second electronic controller; and
a computer connected to the communication network and configured or programmed to rewrite a program of the first electronic controller and a program of the second electronic controller; wherein
the computer is configured or programmed to transmit data for rewriting each of the programs to each of the first and second electronic controllers with a common identifier through the communication network;
the first electronic controller is configured or programmed to:
receive the data;
determine whether or not to rewrite the program thereof;
rewrite the program thereof when it is determined to rewrite the program thereof;
refuse to rewrite the program thereof when it is determined not to rewrite the program thereof; and
the second electronic controller is configured or programmed to:
receive the data;
determine whether or not to rewrite the program thereof;
rewrite the program thereof when it is determined to rewrite the program thereof; and
refuse to rewrite the program thereof when it is determined not to rewrite the program thereof.

7. The watercraft system according to claim 6, further comprising:
a third marine propulsion device including a third electronic controller; wherein
the computer is configured or programmed to determine whether or not each of the first, second, and third electronic controllers is compatible with batch rewriting of the program of the first electronic controller, the program of the second electronic controller, and a program of the third electronic controller with the common identifier;
the computer is configured or programmed to:
transmit the data for rewriting the each of the programs to the each of the first and second electronic controllers with the common identifier when it is determined that the first and second electronic controllers are compatible with the batch rewriting; and
transmit data for rewriting the program of the third electronic controller to the third electronic controller with an identifier uniquely assigned to the third electronic controller so as to be different from the common identifier when it is determined that the third electronic controller is incompatible with the batch rewriting.

8. The watercraft system according to claim 7, wherein the computer is configured or programmed to:
obtain a version of a protocol for rewriting each of the programs of the first, second, and third electronic controllers from the each of the first, second, and third electronic controllers; and
determine whether or not the each of the first, second, and third electronic controllers is compatible with the batch rewriting based on the version of the protocol thereof.

9. The watercraft system according to claim 6, wherein the each of the first and second electronic controllers is configured or programmed to:
determine whether or not a predetermined rewriting condition is satisfied;
determine to rewrite the program thereof when the predetermined rewriting condition is satisfied; and
determine not to rewrite the program thereof when the predetermined rewriting condition is not satisfied.

10. The watercraft system according to claim 9, wherein the predetermined rewriting condition is one of a plurality of rewriting conditions including a condition that a frequency of rewriting the each of the programs has not reached a set value.
